(19) United States
(12) Patent Application Publication
(10) Pub. No.: US 2008/0149800 A1
(43) Pub. Date: Jun. 26, 2008

(54) Flat display drive apparatus

(76) Inventors: Tsutomu Katsumata, Osaka-hu (JP); Takayuki Kaneko, Osaka-hu (JP)

Correspondence Address: NATH & ASSOCIATES, 112 South West Street, Alexandria, VA, 22314, US

(21) Appl. No.: 11/889,064

(22) Filed: Aug. 8, 2007

(30) Foreign Application Priority Data
Aug. 9, 2006 (JP) 2006-216454

(51) Int. Cl. F16M 13/00

(52) U.S. Cl. 248/349.1

(57) ABSTRACT

A flat display drive apparatus is proposed which is capable of driving a flat display to swivel to the left and right in the horizontal direction.

There is provided an drive apparatus for supporting a flat display at the bottom thereof and driving the flat display to swivel to the left and right in the horizontal direction comprising: an electric motor for rotation which is mounted on a base plate for rotation; and a reduction gear train for rotation which serves to reduce the rotation and swivel the flat display to the left and right in the horizontal direction.

### TECHNICAL FIELD

The present invention relates to a flat display drive apparatus capable of driving a flat display such as a liquid crystal display or a plasma display to swivel to the left and right in the horizontal direction, move up and down in the vertical direction, and tilt (bend, lean) in the back-and-forth direction.

### BACKGROUND ART

A conventional drive apparatus for driving a flat display serves to swivel a flat display to the left and right in the horizontal direction by means of an electric motor, and also tilt the flat display in the back-and-forth direction by means of an electric motor (refer to, for example, Japanese Patent Published Application Nos. 2004-258055 and 2004-304679)

On the other hand, there are a display which is swivelled to the left and right in the horizontal direction by hand and tilted in the back-and-forth direction by hand (refer to, for example, Japanese Patent Published Application No. 2005-208080), and a display which is moved up and down in the vertical direction by hand and tilted in the back-and-forth direction by hand (refer to, for example, Japanese Patent Published Application No. 2005-300922).

However, none of the conventional apparatuses as described above can drive a flat display to swivel to the left and right in the horizontal direction, move up and down in the vertical direction, and tilt in the back-and-forth direction, while any of the three types of motion is performed by making use of an electric motor.

### SUMMARY OF THE INVENTION

It is an object of the present invention to provide a drive apparatus capable of driving a flat display to swivel to the left and right in the horizontal direction, move up and down in the vertical direction, and tilt in the back-and-forth direction, and in addition to this, capable of driving the flat display in these types of motion easily and surely by means of an electric motor.

### SUMMARY OF THE INVENTION

According to the present invention, there is provided an drive apparatus for supporting a flat display at the bottom thereof and driving the flat display to swivel to the left and right in the horizontal direction comprising: an electric motor for rotation which is mounted on a base plate for rotation; and a reduction gear train for rotation which serves to reduce the rotation and swivel the flat display to the left and right in the horizontal direction. According to another aspect of the present invention, there is provided an drive apparatus for supporting a flat display at the bottom thereof and tilting the flat display in the back-and-forth direction comprising: an electric motor for tilting motion which is mounted on a base plate for tilting motion; and a reduction gear train for tilting motion which serves to reduce the rotation and tilt the flat display in the back-and-forth direction. According to a further aspect of the present invention, there is provided an drive apparatus for supporting a flat display at the bottom thereof and moving up and down the flat display in the vertical direction comprising: an electric motor for elevator motion which is mounted on an up-down base plate; and a reduction gear train for elevator motion which serves to reduce the rotation and move up and down the flat display. Furthermore, in one embodiment, said electric motor is remotely controlled by a remote control or the like.

In accordance with the flat display drive apparatus of the present invention, there are advantages in that it is possible not only to drive the flat display to swivel to the left and right in the horizontal direction, move up and down in the vertical direction, and tilt in the back-and-forth direction at the same time, but also to drive the flat display in these types of motion easily and surely by means of an electric motor.

### BRIEF DESCRIPTION OF THE DRAWINGS

FIG. 1A is a perspective view for showing the overall configuration of a flat display drive apparatus in accordance with the present invention.

FIG. 1B is an enlarged explanatory view for showing the drive apparatus M of FIG. 1.

FIG. 2A is an operational explanatory view for showing a flat display which has been swivelled to the left.

FIG. 2B is an enlarged explanatory view for showing the drive apparatus of FIG. 2A.

FIG. 2C is an enlarged view for showing a main portion of a reduction gear train of the rotation driving unit.

FIG. 2D is a explanatory view for showing the installation of a rotation regulating plate.

FIG. 2E is an operational explanatory view for showing the flat display which has been swivelled to the right.

FIG. 3A is an operational explanatory view for showing the flat display which has been elevated.

FIG. 3B is an enlarged explanatory view for showing the elevator driving unit of FIG. 3A.

FIG. 3C is a perspective explanatory view for showing the reduction gear train for elevator motion.

FIG. 4A is an operational explanatory view for showing the flat display which has been tilted forward.

FIG. 4B is an enlarged explanatory view for showing the drive apparatus of FIG. 4A.

FIG. 4C is a perspective explanatory view for showing the reduction gear train for tilting motion.

FIG. 4D is an operational explanatory view for showing the tilting motion.

FIG. 4E is an operational explanatory view for showing the flat display D which has been tilted backward.

FIG. 5 is an enlarged explanatory view for showing the drive apparatus of the embodiment 2 in accordance with the present invention.

FIG. 6 is a perspective view for showing the apparatus of FIG. 5 as seen from the opposite side.

FIG. 7 is a perspective view for showing the main portion of the elevator driving unit.

FIG. 8 is a perspective view for showing the mechanism of FIG. 7 as seen from the bottom.

FIG. 9 is a perspective explanatory view for showing the elevated state.

FIG. 10 is a explanatory view for showing the flat display which has been elevated.

### DESCRIPTION OF THE PREFERRED EMBODIMENTS

Next, examples of the drive apparatuses in accordance with the present invention will be explained with reference to the accompanying drawings.

### EXAMPLE 1

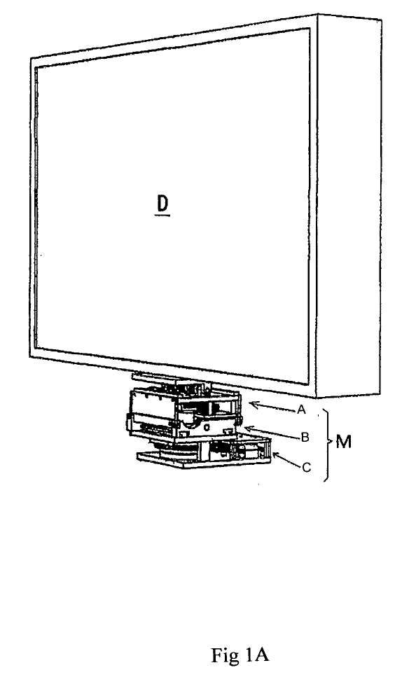

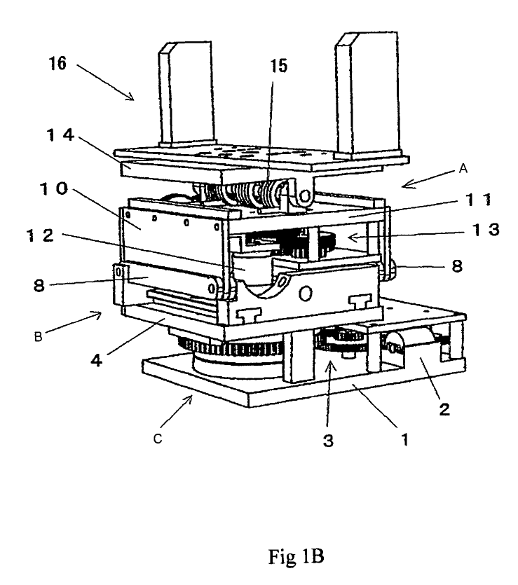

FIG. 1A is a perspective view for showing the overall configuration of a flat display drive apparatus in accordance with the present invention, in which D is a flat display such as a liquid crystal display or a plasma display, and M is a flat display drive apparatus capable of supporting the flat display D at the bottom thereof and driving it to swivel to the left and right in the horizontal direction, move up and down, and tilt forward and backward. As apparent from FIG. 1B, the flat display drive apparatus is composed of a rotation driving unit A, an elevator driving unit B and a tilt driving unit C. The base portion of the drive apparatus M, i.e., a rotation base plate 1 of the rotation driving unit is configured to be fixedly mounted to an appropriate support means (not shown in the figure) such as an installation mount or structure, for example, a stand or rack.

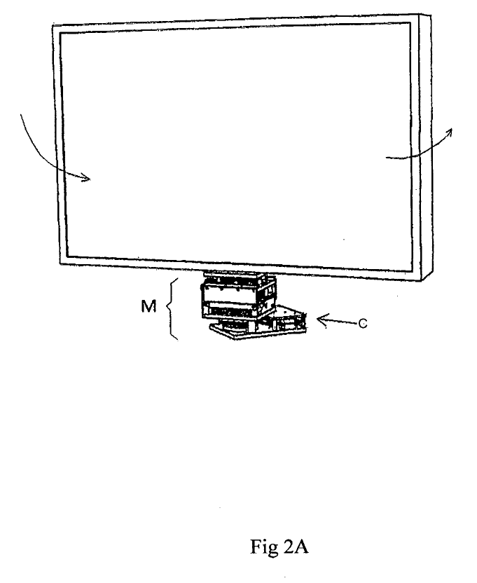

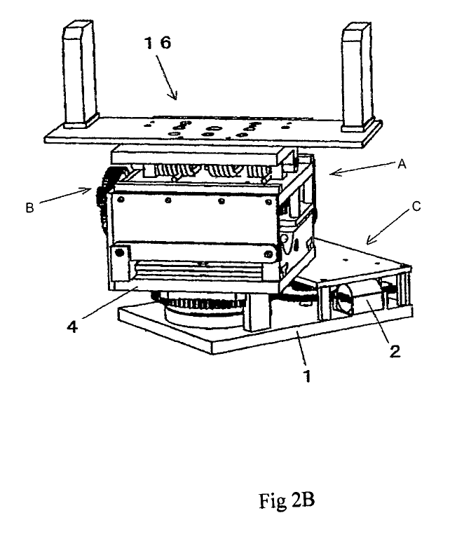

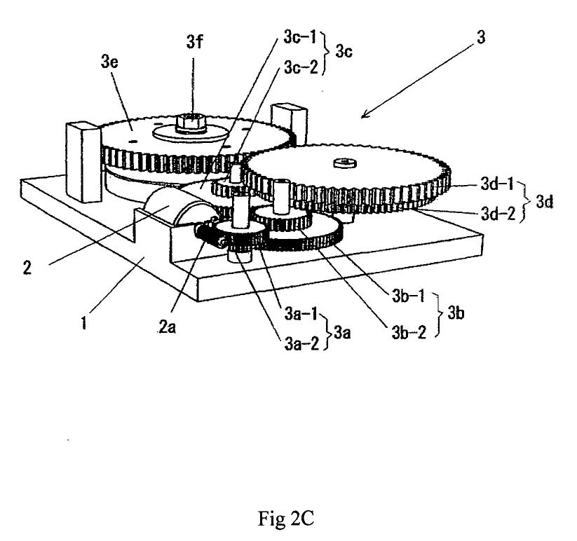

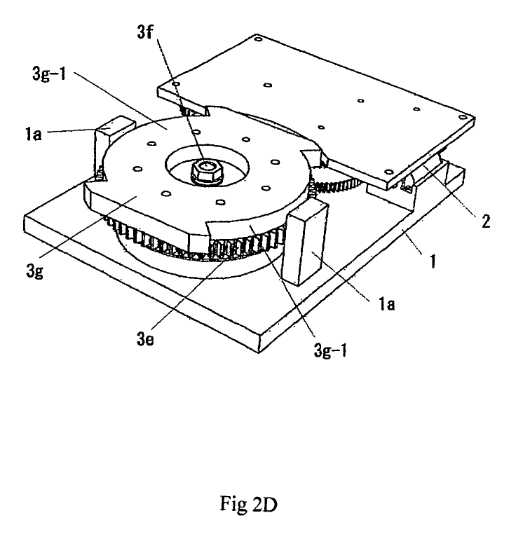

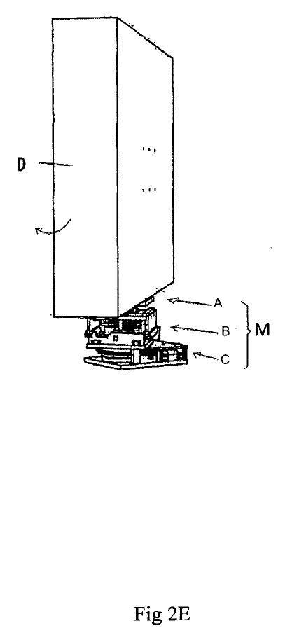

FIG. 2A is a view for showing the flat display D which has been swivelled by the rotation driving unit A to the left in the horizontal direction (in the clockwise direction as seen from the above, same as below) as indicated by arrows. FIG. 2B is an enlarged view of the drive apparatus M. FIG. 2C is a view for showing a reduction gear train of the rotation driving unit A. An electric motor 2 for rotation installed in the rotation base plate 1 has an output rotation shaft onto which is fitted a worm gear 2a engaged with a large gear 3a-1 of a first gear 3a. A small gear 3a-2 of the first gear 3a is engaged with a large gear 3b-1 of a second gear 3b, and a small gear 3b-2 of the second gear 3b is engaged with a large gear 3c-1 of a third gear 3c. A small gear 3c-2 of the third gear 3c is engaged with a small gear 3d-2 of a fourth gear 3d. A large gear 3d-1 of the fifth gear 3d is engaged with a fifth gear 3e. The worm gear 2a and the rotation reduction gear train 3 as described above serve to substantially reduce the rotation of the electric motor 2 for rotation.

The above fifth gear 3e has an output rotary shaft 3f to which is fixedly attached a rotation regulating plate 3g as illustrated in FIG. 2D. However, an appropriate clutch (not shown in the figure) is interposed between the rotation regulating plate 3g and the output rotary shaft 3f, such that when an overload is applied to the rotation regulating plate 3g, the output rotary shaft 3f is disengaged to rotate idly. The rotation regulating plate 3g is formed with cut portions 3g-1 which is extending in the circumferential direction for a predetermined angle in order to regulate the rotation thereof by means of stoppers 1a which are fixed to the rotation base plate 1.

An base plate 4 for elevator motion (refer to FIG. 2B) is mounted on the regulating plate 3g such that they can be rotated integrally, and the flat display D is rotatably driven with the elevator driving unit B and the tilt driving unit C which are interposed therebetween.

FIG. 2E is a view for showing the flat display D which has been swivelled in the counter direction, i.e., to the right in the horizontal direction (the clockwise direction, and so on) by rotating the electric motor 2 for rotation in the counter direction.

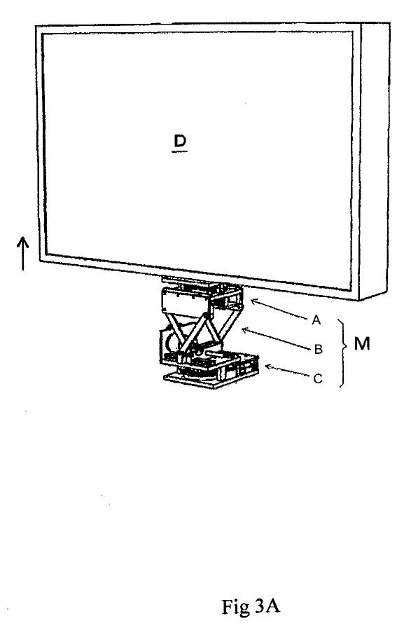

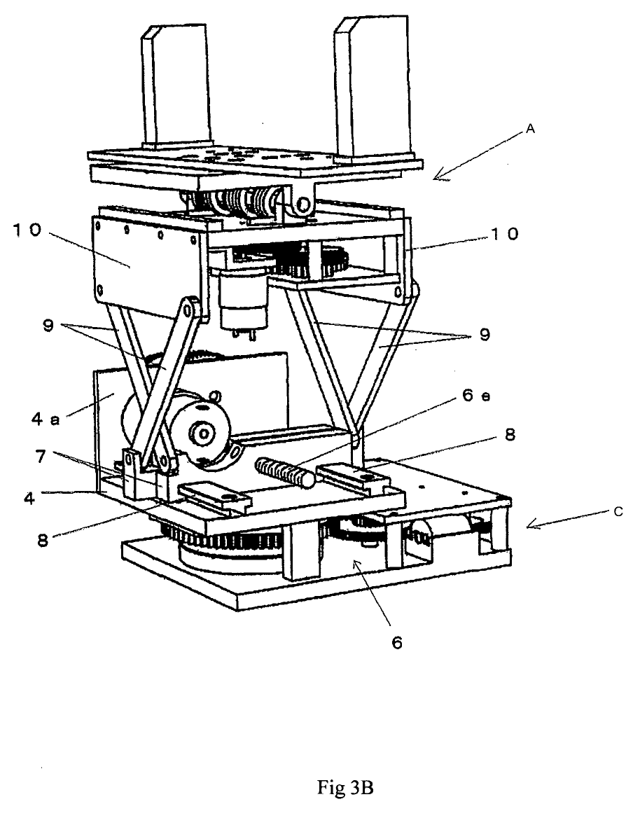

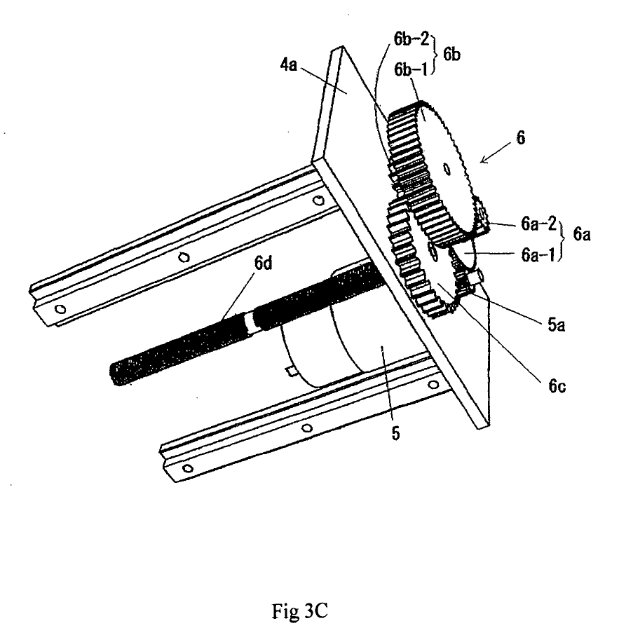

FIG. 3A is a view for showing the flat display D which has been elevated from the position shown in FIG. 1 as indicated with an arrow, and particularly FIG. 3B is an enlarged view of the elevator driving unit B. An electric motor 5 for elevator motion and a reduction gear train 6 are mounted on a side plate 4a which rises at a right angle from the base plate 4 for elevator motion which is provided in a horizontal position.

As shown in FIG. 3C, the pinion gear 5a fixed to the output rotation shaft of the electric motor 5 for elevator motion is engaged with a large gear 6a-1 of a first gear 6a. A small gear 6a-2 of the first gear 6a is engaged with the large gear 6b-1 of the second gear 6b. A small gear 6b-2 of the second gear 6b is engaged with a third gear 6c. By virtue of the pinion gear 5a and the elevation reduction gear train 6 as described above, the rotation of the electric motor 5 for elevator motion is substantially reduced.

An output screw shaft 6d for elevator motion is integrally fixed to the above third gear 6c. The output screw shaft 6d for elevator motion is formed with threads reversely spiraling to the right and left from the center thereof in the longitudinal direction. The respective threads are threaded into slide frames 7, 7 respectively as illustrated in FIG. 3B, and the slide frames 7, 7 are moved towards or away from each other in association with the rotation of the output screw shaft 6d for elevator motion. Reference 8 indicates a guide rail serving to guide the slide frames 7, 7.

Reference 9 indicates is a pantograph type elevator structure having lower ends pivotally connected to the slide frames 7, 7 and upper ends pivotally connected to the elevation side flames 10, 10. Accordingly, the elevation side flames 10, 10 are moved up and down, i.e., rise and fall in association with the motion of the slide frames 7, 7, such that the flat display D is moved up or down together with the tilt driving unit C.

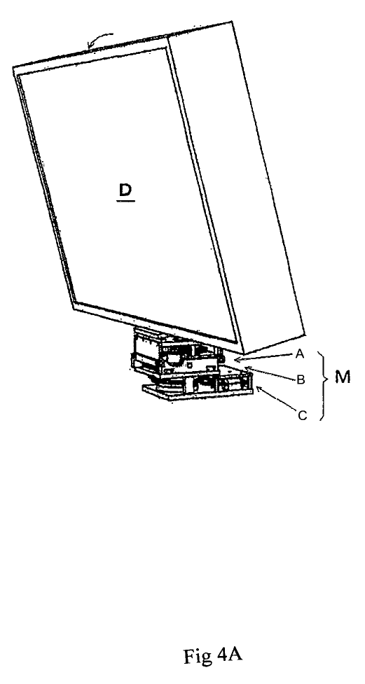

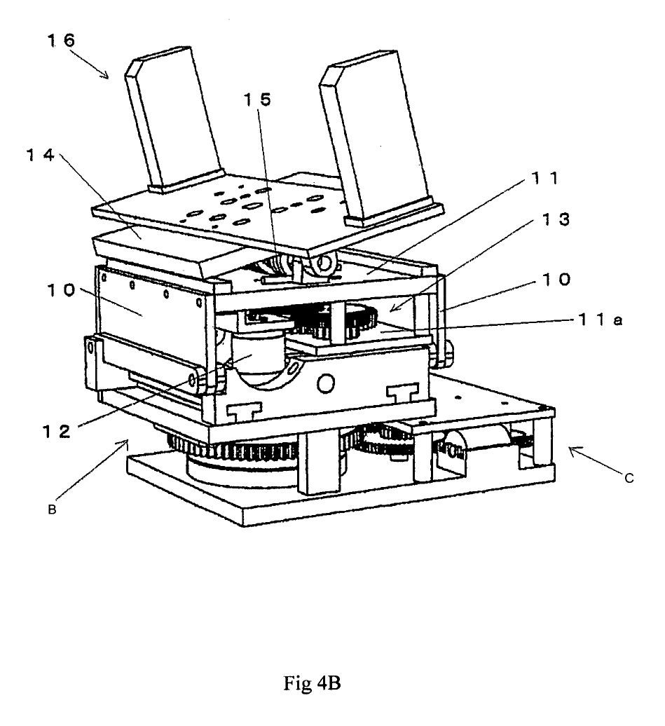

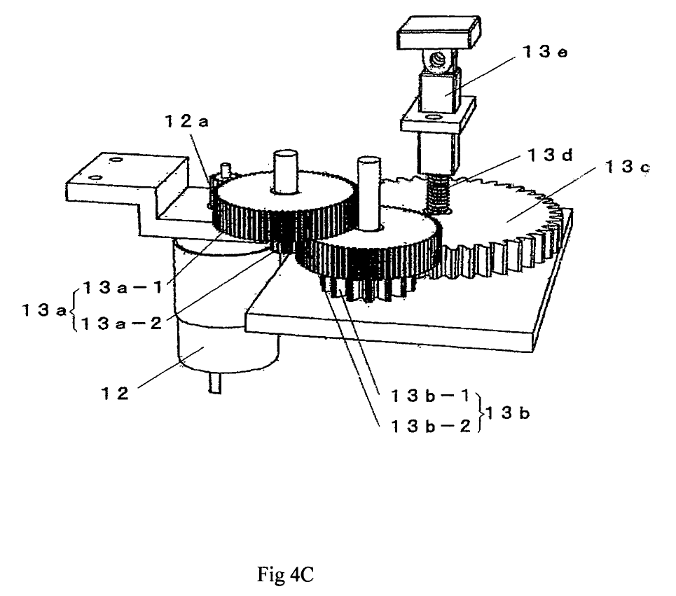

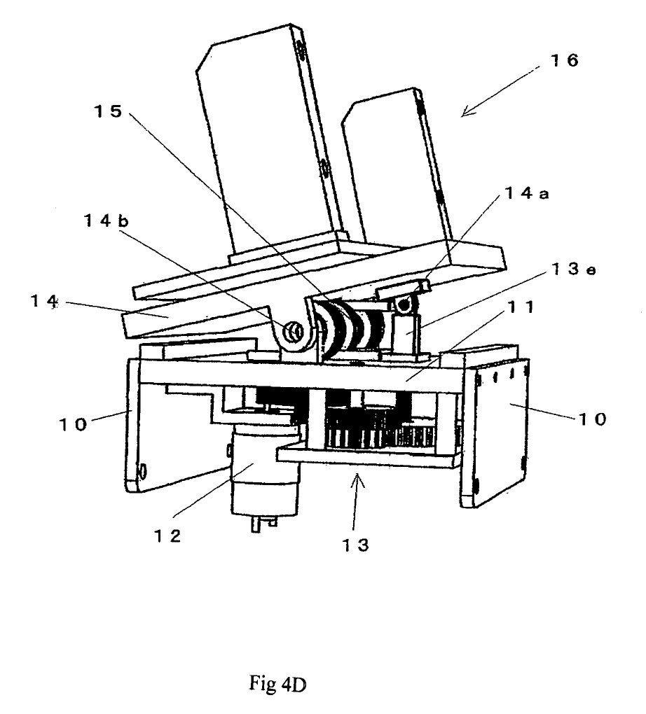

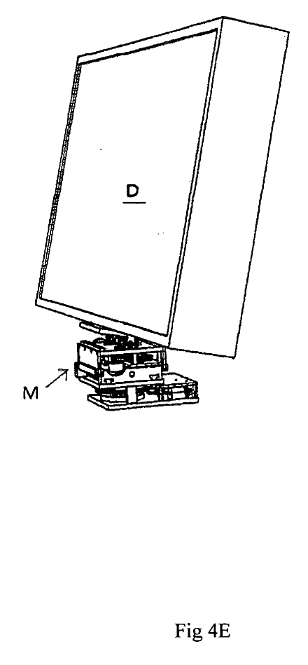

FIG. 4A is a schematic view for showing the flat display D tilted forward from the position stored in FIG. 1, and FIG. 4B is an enlarged view of the tilt driving unit C. In this figure, an electric motor 12 for tilting motion is fixed to a base plate 11 for tilting motion which is attached to the upper portions of the elevation side flames 10, 10.

As shown in FIG. 4C, the pinion gear 12a fixed to the output rotary shaft of the electric motor 12 for tilting motion is engaged with a large gear 13a-1 of a first gear 13a. A small gear 13a-2 of the first gear 13a is engaged with a large gear 13b-2 of a second gear 13b. A small gear 13b-1 of the second gear 13b is engaged with a third gear 13c. By virtue of the pinion gear 12a and the elevation reduction gear train 13 for tilting motion as described above, the rotation of the electric motor 12 for tilting motion is substantially reduced.

An output screw shaft 13d for tilting motion is integrally fixed to the above third gear 13c. The output screw shaft 13d for tilting motion is threaded into a moving piece 13e which is moved up and down in association with the rotation of the output screw shaft 13d for tilting motion.

As is apparent from FIG. 4D, the moving piece 13e is coupled to a tilting plate 14 through a hinge member 14a. The hinge member 14 is pivotally connected to the base plate 11 for tilting motion through the pivotal shaft 14b. Since the hinge member 14a is displaced with respect to the pivotal shaft 14b, the tilting plate 14 is tilted in association with the vertical motion of the moving piece 13e such that the flat display D is tilted back and forth through a display attachment member 16. Reference 15 indicates a torsion spring which is provided for achieving a balance with respect to the back and forth motion of the flat display D.

FIG. 4E is a view for showing the flat display D which has been tilted backward by rotating the electric motor 12 for tilting motion in the reverse direction.

### EXAMPLE 2

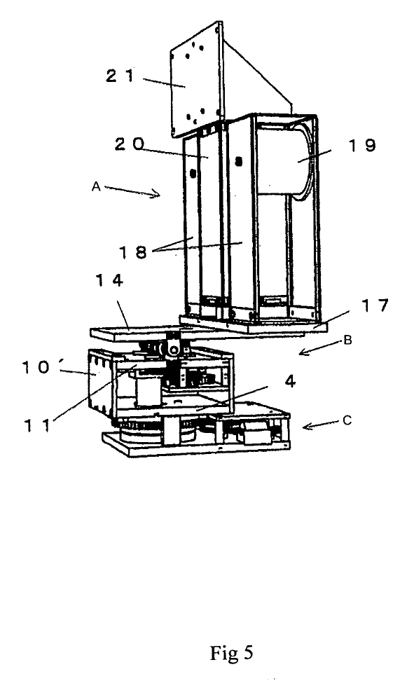

In the case of the above embodiment 1, as an elevator means for moving the flat display D up and down, there are provided the output screw shaft for elevator motion as the output shaft of the above reduction gear train, the slide frames into which is threaded the output screw shaft for elevator motion to slide and move the slide frames, and the pantograph type elevator structure having the upper ends which are moved up and down in association with the motion of the slide frames to move up and down the base plate for tilting motion coupled to the upper ends. The elevator driving unit B is interposed as the elevator means between the rotation driving unit A and the tilt driving unit C. However, in the case of the present embodiment 2, the tilt driving unit C is mounted on the rotation driving unit A, and an elevator driving unit B′ is mounted on the tilt driving unit C as illustrated in FIG. 5.

As apparent from FIG. 5, the connection between the above rotation driving unit A and the tilt driving unit C is made by the rotary plate 4′ corresponding to the base plate 4 for elevator motion of the embodiment 1 and the base plate 11 for tilting motion of the tilt driving unit C through side plates 10′ (corresponding to the elevation side flames 10, 10 of the embodiment 1).

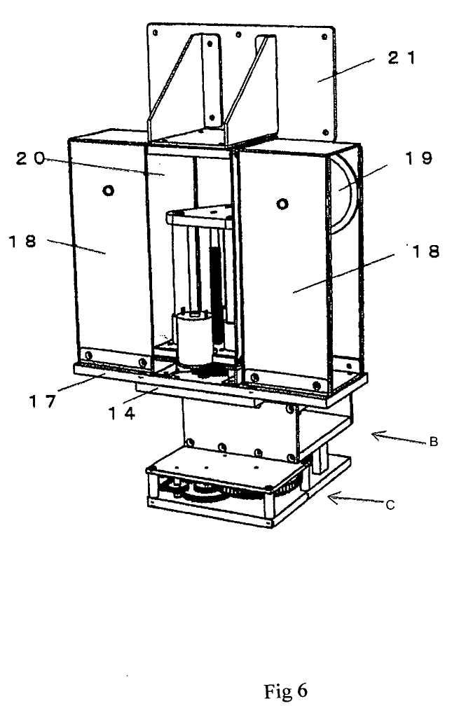

The above elevator driving unit B′ is provided with an up-down base plate 17 which is fixedly mounted to the tilting plate 14 of the above tilt driving unit C. As apparent also from FIG. 6, a pair of guide frames 18 are fixedly attached to the up-down base plate 17 in the right and left sides. A constant force spring conston 19 is provided in the upper portion of each of the respective right and left guide frames 18.

A up-down slide frame 20 is provided between the right and left guide frames 18, and fixedly connected to and supported by the ends of the constant force spring constons 19 at lower positions thereof such that it can be moved in the vertical direction. The up-down slide frame 20 is provided at its upper end with a display attachment frame 21 on which the flat display D can be fixedly mounted.

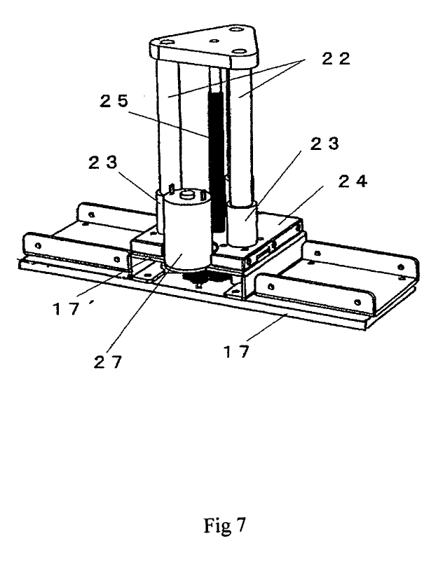

FIG. 7 is an explanatory view for showing the vertical motion (sliding) mechanism in which an appropriate number (three in the case of the present embodiment) of support posts 22 are implanted in a frame 17′ which is fixed to the up-down base plate 17. Slide sleeves 23 are fitted onto these support posts 22 respectively such that they can be slid in the vertical direction. The slide sleeves 23 are provided with a vertical motion plate 24. This vertical motion plate 24 is formed with a screw hole into which an output screw shaft for elevator motion 25 is threaded.

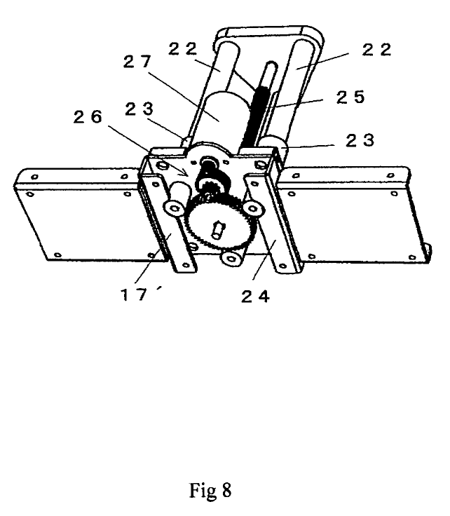

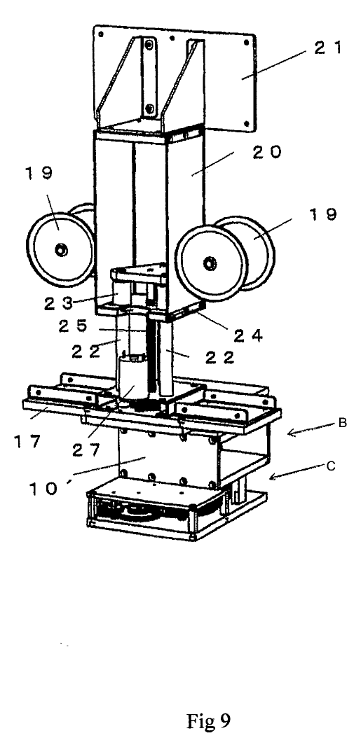

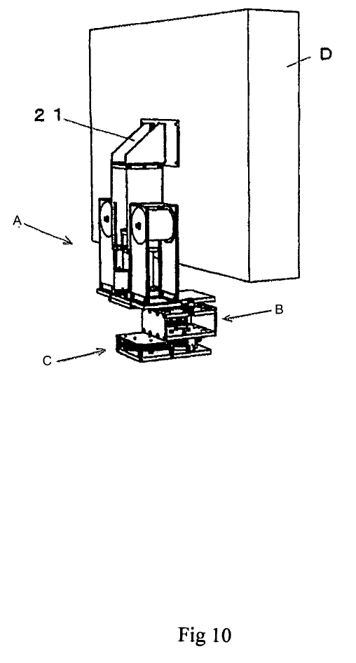

In FIG. 8, the output screw shaft 25 for elevator motion is rotationally driven by an electric motor 27 for elevator motion through a reduction gear train 26, and in association with the rotation thereof the vertical motion plate 24 is moved up and down, such that the flat display D can be moved up and down as illustrated in FIG. 10 when the up-down slide frame 20 and the display attachment frame 21 are moved up and down integrally with the vertical motion plate 24 as illustrated in FIG. 9.

Meanwhile, in the case of the above embodiments 1 and 2, the tilting means for tilting motion the tilting plate is composed of the output screw shaft for tilting motion as the output shaft of the reduction gear train for tilting motion, and the moving piece which is moved up and down by the output screw shaft for tilting motion threaded thereinto. However, the tilting means of the present invention is not limited thereto.

In addition, the respective electric motors 2, 5, 12 and 27 are remotely controlled by wired or wireless means.

While there are provided in the case of the above embodiments 1 and 2 the respective mechanisms for rotary motion in the horizontal direction, tilting motion in the back-and-forth direction and elevator motion in the up-and-down direction, it is possible to make use of only one mechanism or combination of two mechanisms. In this case, if only the horizontal rotation mechanism is implemented in the embodiment 1, the flat display D is connected directly to the regulating plate 3g as described above. Alternatively, if there is combined only the horizontal rotation mechanism and the back-and-forth tilting mechanism, the flat display D is connected directly to the tilting plate. Furthermore, if only the back-and-forth tilting mechanism is implemented, the mechanism is connected directly to the base plate, and the display D is connected directly to the tilting plate, while dispensing with the horizontal rotation mechanism and the up-and-down elevator mechanism. Still further, if there is combined only the back-and-forth tilting mechanism and the up-and-down elevator mechanism, the mechanisms are connected to the base plate, while dispensing with the horizontal rotation mechanism located below the rotary plate. Still further, if only the up-and-down elevator mechanism is implemented, the mechanism is connected directly to the base plate, while dispensing with the horizontal rotation mechanism and the back-and-forth tilting mechanism.

In the case of the embodiment 2, if only the horizontal rotation mechanism is implemented, the flat display D is connected directly to the base plate 4 for elevator motion. Still further, if there is combined only the horizontal rotation mechanism and the back-and-forth tilting mechanism, the flat display D is connected directly to the tilting plate 14. Still further, if only the back-and-forth tilting mechanism, the mechanism is connected directly to the base plate, and the display D is connected directly to the tilting plate 14, while dispensing with the horizontal rotation mechanism located below the base plate 4 for elevator motion and the up-and-down elevator mechanism. Still further, if there is combined only the back-and-forth tilting mechanism and the up-and-down elevator mechanism, the mechanisms are connected to the base plate, while dispensing with the horizontal rotation mechanism located below the base plate 4 for elevator motion. Still further, if only the up-and-down elevator mechanism is implemented, the mechanism is connected directly to the base plate, while dispensing with the mechanisms located below the tilting plate 14 as described above.

While the present invention has been described in terms of embodiments, it is apparent to those skilled in the art that the invention is not limited to the embodiments described. The present invention can be practiced with modification and alteration within the spirit and scope of the appended claims. The description is thus to be regarded as illustrative instead of limiting in any way on the present invention.

1. An drive apparatus for supporting a flat display at the bottom thereof and driving the flat display to swivel to the left and right in the horizontal direction comprising:
an electric motor for rotation which is mounted on a base plate for rotation; and a reduction gear train for rotation which serves to reduce the rotation and swivel the flat display to the left and right in the horizontal direction.

2. The flat display drive apparatus as claimed in claim 1 wherein said electric motor is remotely controlled by a remote control or the like.

3. An drive apparatus for supporting a flat display at the bottom thereof and tilting the flat display in the back-and-forth direction comprising:
an electric motor for tilting motion which is mounted on a base plate for tilting motion; and a reduction gear train for tilting motion which serves to reduce the rotation and tilt the flat display in the back-and-forth direction.

4. The flat display drive apparatus as claimed in claim 3 wherein said electric motor is remotely controlled by a remote control or the like.

5. An drive apparatus for supporting a flat display at the bottom thereof and moving up and down the flat display in the vertical direction comprising:
an electric motor for elevator motion which is mounted on an up-down base plate; and a reduction gear train for elevator motion which serves to reduce the rotation and move up and down the flat display.

6. The flat display drive apparatus as claimed in claim 5 wherein said electric motor is remotely controlled by a remote control or the like.
